(19) United States
(12) Patent Application Publication
(10) Pub. No.: US 2026/0238437 A1
(43) Pub. Date: Aug. 13, 2026

(54) PHASE TRACKING REFERENCE SIGNALING WITH ORTHOGONAL COVER CODING

(71) Applicant: QUALCOMM Incorporated, San Diego, CA (US)

(72) Inventors: Syed Hashim Ali SHAH, Cambridge, MA (US); Alberto RICO ALVARINO, San Diego, CA (US); Xiao Feng WANG, San Diego, CA (US); Brahim SAADI, Nuremberg (DE); Changhwan PARK, San Diego, CA (US); Jae Ho RYU, San Diego, CA (US); Ayan SENGUPTA, Mountain View, CA (US); Peter GAAL, San Diego, CA (US); Enoch Shiao-Kuang LU, San Diego, CA (US)

(21) Appl. No.: 19/323,987

(22) Filed: Sep. 9, 2025

Related U.S. Application Data
(60) Provisional application No. 63/755,811, filed on Feb. 7, 2025.

(51) Int. Cl. H04L 5/00

(52) U.S. Cl. CPC H04L 5/0051; H04L 5/0016

(57) ABSTRACT

Various aspects of the present disclosure generally relate to wireless communication. In some aspects, a user equipment (UE) may transmit a UE capability indication associated with multiplexing. The UE may receive an orthogonal cover code (OCC) configuration that indicates an OCC-multiplexing factor. The UE may transmit or refrain from transmitting a phase tracking reference signal (PTRS) in accordance with a PTRS rule associated with the OCC configuration. Numerous other aspects are described.

### CROSS-REFERENCE TO RELATED APPLICATION

This Patent Application claims priority to U.S. Provisional Patent Application No. 63/755,811, filed on Feb. 7, 2025, entitled “PHASE TRACKING REFERENCE SIGNALING WITH ORTHOGONAL COVER CODING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with phase tracking reference signals with orthogonal cover coding.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A multiple access scheme can increase capacity by multiplexing a user equipment (UE) with at least one other UE. For example, the multiple access scheme may increase capacity by increasing a quantity of UEs that can use a given set of time-frequency resources, compared to scenarios where the multiple access scheme is not implemented. However, multiplexing UEs can create interference at a network node. Accordingly, orthogonal cover codes (OCCs) can be used to mitigate interference resulting from the multiple access scheme.

### SUMMARY

Some aspects described herein relate to a user equipment (UE). The UE may include a processing system that includes processor circuitry and code-storing memory circuitry. The processing system may be configured to cause the UE to transmit a UE capability indication associated with multiplexing. The processing system may be configured to cause the UE to receive an orthogonal cover code (OCC) configuration that indicates an OCC-multiplexing factor. The processing system may be configured to cause the UE to transmit or refrain from transmitting a phase tracking reference signal (PTRS) in accordance with a PTRS rule associated with the OCC configuration.

Some aspects described herein relate to a network node. The network node may include a processing system that includes processor circuitry and code-storing memory circuitry. The processing system may be configured to cause the network node to receive a UE capability indication associated with multiplexing. The processing system may be configured to cause the network node to transmit an OCC configuration that indicates an OCC-multiplexing factor. The processing system may be configured to cause the network node to receive or refrain from receiving a PTRS in accordance with a PTRS rule associated with the OCC configuration.

Some aspects described herein relate to a method of wireless communication performed by a UE. The method may include transmitting a UE capability indication associated with multiplexing. The method may include receiving an OCC configuration that indicates an OCC-multiplexing factor. The method may include transmitting or refraining from transmitting a PTRS in accordance with a PTRS rule associated with the OCC configuration.

Some aspects described herein relate to a method of wireless communication performed by a network node. The method may include receiving a UE capability indication associated with multiplexing. The method may include transmitting an OCC configuration that indicates an OCC-multiplexing factor. The method may include receiving or refraining from receiving a PTRS in accordance with a PTRS rule associated with the OCC configuration.

Some aspects described herein relate to an apparatus for wireless communication. The apparatus may include means for transmitting an apparatus capability indication associated with multiplexing. The apparatus may include means for receiving an OCC configuration that indicates an OCC-multiplexing factor. The apparatus may include means for transmitting or refraining from transmitting a PTRS in accordance with a PTRS rule associated with the OCC configuration.

Some aspects described herein relate to an apparatus for wireless communication. The apparatus may include means for receiving a UE capability indication associated with multiplexing. The apparatus may include means for transmitting an OCC configuration that indicates an OCC-multiplexing factor. The apparatus may include means for receiving or refraining from receiving a PTRS in accordance with a PTRS rule associated with the OCC configuration.

Some aspects described herein relate to a non-transitory computer-readable medium that stores a set of instructions for wireless communication by a UE. The set of instructions, when executed by one or more processors of the UE, may cause the UE to transmit a UE capability indication associated with multiplexing. The set of instructions, when executed by one or more processors of the UE, may cause the UE to receive an OCC configuration that indicates an OCC-multiplexing factor. The set of instructions, when executed by one or more processors of the UE, may cause the UE to transmit or refrain from transmitting a PTRS in accordance with a PTRS rule associated with the OCC configuration.

Some aspects described herein relate to a non-transitory computer-readable medium that stores a set of instructions for wireless communication by a network node. The set of instructions, when executed by one or more processors of the network node, may cause the network node to receive a UE capability indication associated with multiplexing. The set of instructions, when executed by one or more processors of the network node, may cause the network node to transmit an OCC configuration that indicates an OCC-multiplexing factor. The set of instructions, when executed by one or more processors of the network node, may cause the network node to receive or refrain from receiving a PTRS in accordance with a PTRS rule associated with the OCC configuration.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims.

Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of using an orthogonal cover code (OCC) for a first user equipment (UE) and a second UE.

FIG. 4 is a diagram illustrating an example of a physical uplink shared channel allocation for one orthogonal frequency-division multiplexing slot and one resource block.

FIG. 5 is a diagram illustrating an example of signaling associated with rules for configuration of uplink phase tracking reference signals (PTRSs) with OCC.

FIG. 6 is a diagram illustrating an example where the PTRS rule indicates that PTRS transmission is performed using an OCC codeword.

FIG. 7 is a diagram illustrating an example where the PTRS rule indicates that PTRS transmission is not performed using an OCC codeword.

FIG. 8 is a diagram illustrating an example process performed, for example, at a UE or an apparatus of a UE.

FIG. 9 is a diagram illustrating an example process performed, for example, at a network node or an apparatus of a network node.

FIG. 10 is a diagram of an example apparatus for wireless communication.

FIG. 11 is a diagram of an example apparatus for wireless communication.

### DETAILED DESCRIPTION

Orthogonal cover codes (OCCs) allow a user equipment (UE) in a multiple access scheme to multiplex a signal with at least one other signal from another UE orthogonally, which can reduce interference at a network node. Using OCCs, data to be transmitted by a given one of the multiplexed UEs may be cover-coded across repetitions (e.g., transport block over multiple slots (TBoMS) repetitions). Due to the repetitive nature of uplink transmissions, wireless communication systems can perform OCC-based multiplexing without increased resource usage (for example, as compared to using a code division multiple access (CDMA) based scheme).

“Carrier frequency offset” (CFO) refers to an impairment whereby a carrier signal contained in a received signal is shifted in frequency relative to a frequency of a local oscillator of the network node. Accordingly, an uplink phase tracking reference signal (PTRS) may be provided that enables a network node to suppress CFO. For example, a UE may transmit, and a network node may receive, an uplink PTRS, and the network node may use the PTRS to estimate and compensate for the CFO.

Whether or how a physical uplink shared channel (PUSCH) using OCC allows for PTRS transmission can impact one or more of CFO estimation, capacity, overhead, performance, or the like. For example, if a system that is using OCC and sensitive to CFO cannot use uplink PTRS, then the network may be unable to accurately estimate CFO and, thus, may be unable to accurately decode the PUSCH. As a result, the performance of the system may suffer, which may lead to decreased uplink capacity.

Additionally, or alternatively, if a system that is using OCC and has limited bandwidth uses uplink PTRS, then the PTRS may increase overhead and use resources that could otherwise be used for data. Such systems may sufficiently estimate CFO using demodulation reference signals (DMRSs). Additionally, or alternatively, if a system that is using OCC has a low link budget, then the PTRS may offer at most incremental help in estimating impairments accurately and contribute to additional overhead, which may decrease uplink capacity. As a result, depending on the system that uses OCC, uplink PTRS may or may not be helpful on balance.

Various aspects relate generally to configuration of PTRS for systems using PUSCH with OCC. Some aspects more specifically relate to various rules for PTRS configuration or transmission for UEs configured with OCC. In some aspects, the rules relate to whether or not a UE configured with OCC can also be configured with PTRS. In some aspects, the rules relate to whether or not a UE configured with OCC and PTRS can transmit a PTRS. In some aspects, the rules relate to how a UE configured with OCC and PTRS can transmit a PTRS.

In some aspects, a rule may prohibit OCC and PTRS from being configured together. In some aspects, a rule may prohibit the UE from using PTRS in uplink transmissions if OCC and PTRS are configured together. In some aspects, a rule may permit the UE to use OCC for PTRS transmission if OCC and PTRS are configured together. In some aspects, a rule may permit the UE to transmit PTRS without OCC if OCC and PTRS are configured together.

Particular aspects of the subject matter described in this disclosure can be implemented to realize one or more of the following potential advantages. In some examples, the described techniques can be used to improve a CFO estimation, capacity, overhead, performance, or the like. For example, if the UE is using OCC and uplink communications are sensitive to CFO, then the PTRS rule may allow the UE to use uplink PTRS, which may enable the network node to accurately estimate CFO and, thus, accurately decode the PUSCH. As a result, performance may improve, which may lead to increased uplink capacity. Additionally, or alternatively, if the UE is using OCC and the uplink communications have limited bandwidth, then the PTRS rule may cause the UE to skip uplink PTRS, which may help to decrease overhead and provide additional resources that can be used for data. Additionally, or alternatively, if the UE is using OCC and has a low link budget, then the PTRS rule may cause the UE to skip uplink PTRS, which may help to decrease overhead and, thus, increase uplink capacity.

Prohibiting OCC and PTRS from being configured together may help to reduce overhead by skipping PTRS configuration. Additionally, or alternatively, processing or memory resource utilization at the UE may be reduced because the UE may avoid identifying whether the UE can transmit a PTRS. Prohibiting the UE from using PTRS in uplink transmissions may help to reduce processing or memory resource utilization at the network node by enabling the network node to avoid identifying whether the UE can receive a PTRS configuration. Permitting the UE to use OCC for PTRS transmission may help to improve uplink capacity by enabling multiplexing of PTRS using OCC. Additionally, or alternatively, processing or memory resource utilization at the network node may be reduced because the network node may avoid precise scheduling of PTRSs whereby all PTRS resources are used by the multiplexed in a non-overlapping manner. Permitting the UE to transmit PTRS without OCC may help to reduce processing or memory resource utilization at the UE by allowing the UE to avoid applying OCC codewords to PTRSs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

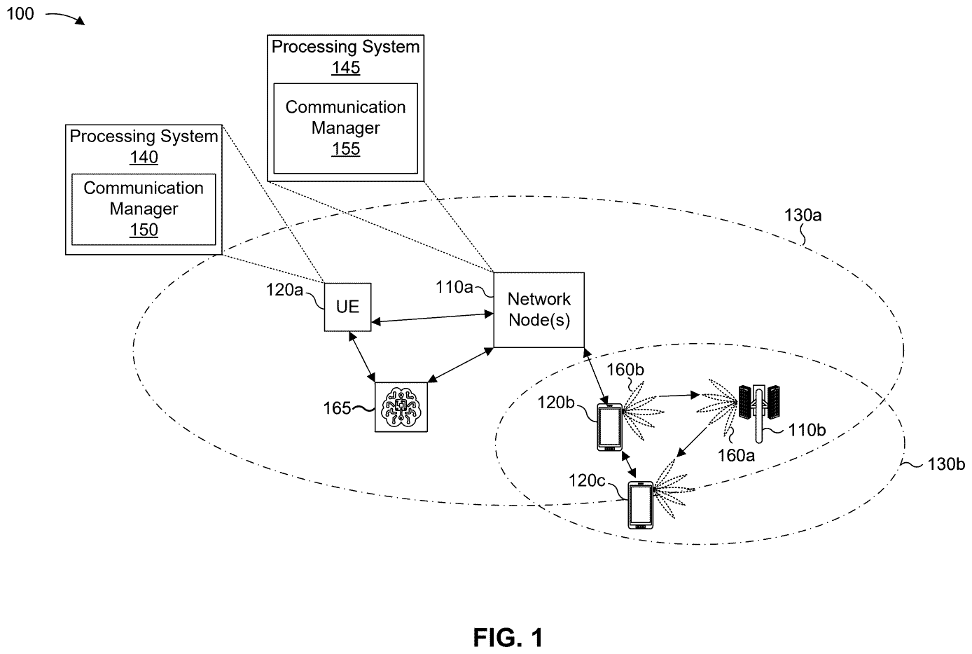

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit a UE capability indication associated with multiplexing; receive an OCC configuration that indicates an OCC-multiplexing factor; and transmit or refrain from transmitting a PTRS in accordance with a PTRS rule associated with the OCC configuration. Additionally, or alternatively, the communication manager 150 may perform one or more other operations described herein.

In some aspects, the network node 110 may include a communication manager 155. As described in more detail elsewhere herein, the communication manager 155 may receive a UE capability indication associated with multiplexing; transmit an OCC configuration that indicates an OCC-multiplexing factor; and receive or refrain from receiving a PTRS in accordance with a PTRS rule associated with the OCC configuration. Additionally, or alternatively, the communication manager 155 may perform one or more other operations described herein.

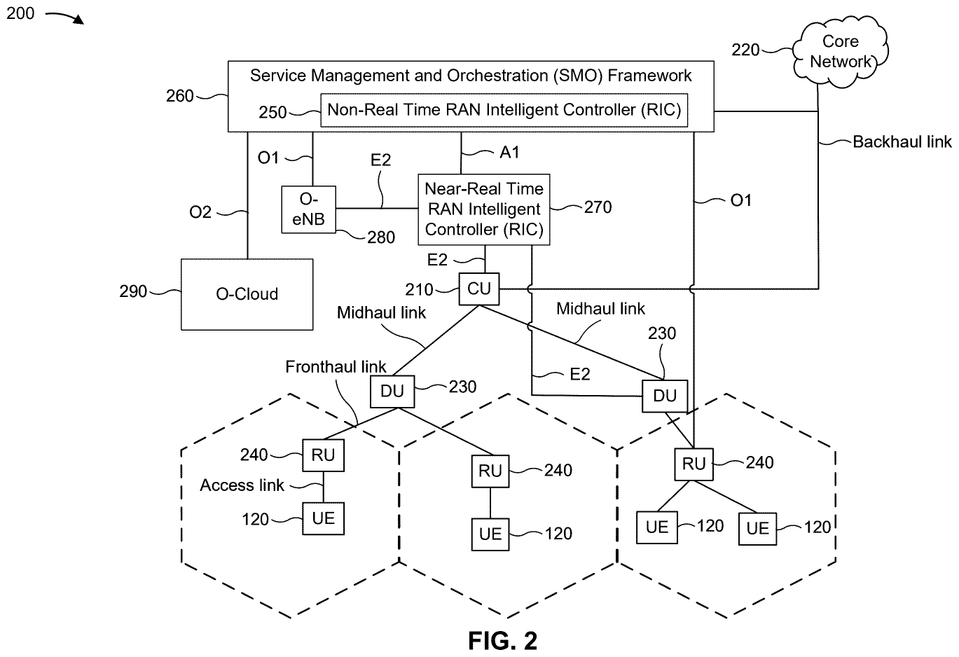

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

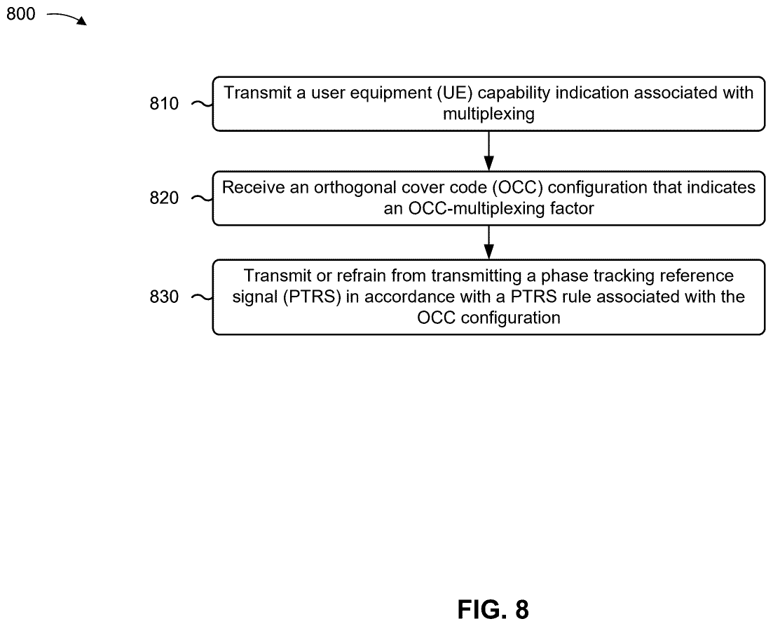

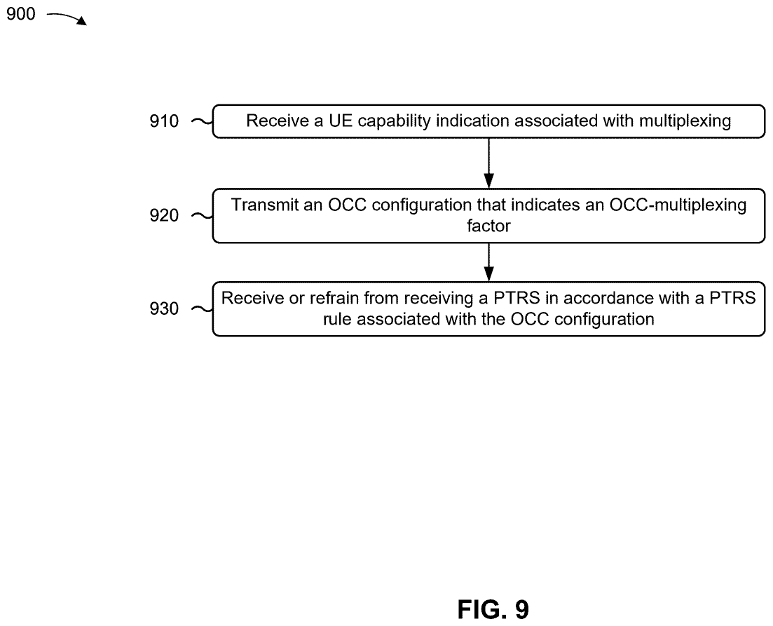

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with PTRS with OCC, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

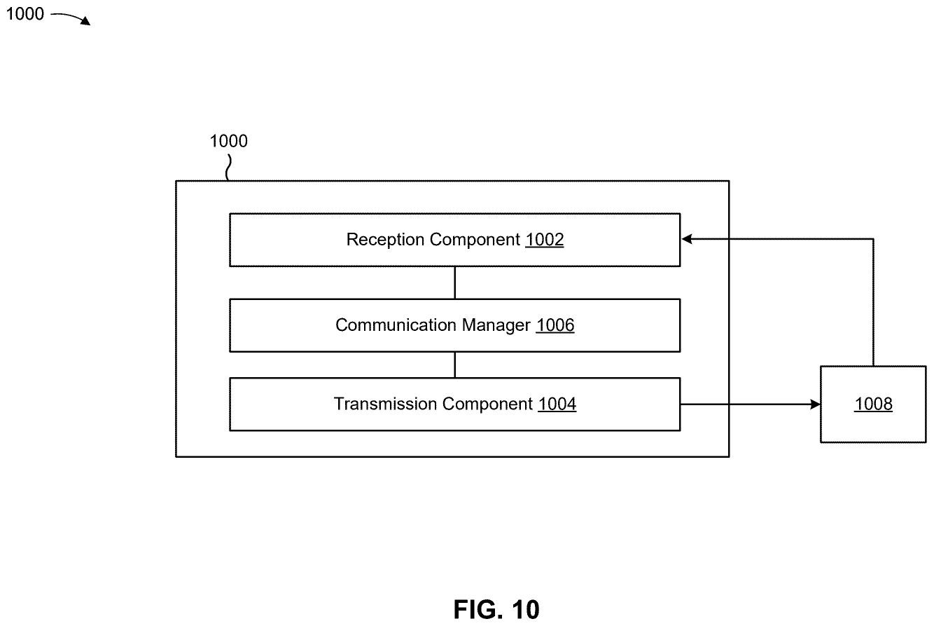

In some aspects, the UE 120 includes means for transmitting a UE capability indication associated with multiplexing; means for receiving an OCC configuration that indicates an OCC-multiplexing factor; or means for transmitting or refraining from transmitting a PTRS in accordance with a PTRS rule associated with the OCC configuration. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

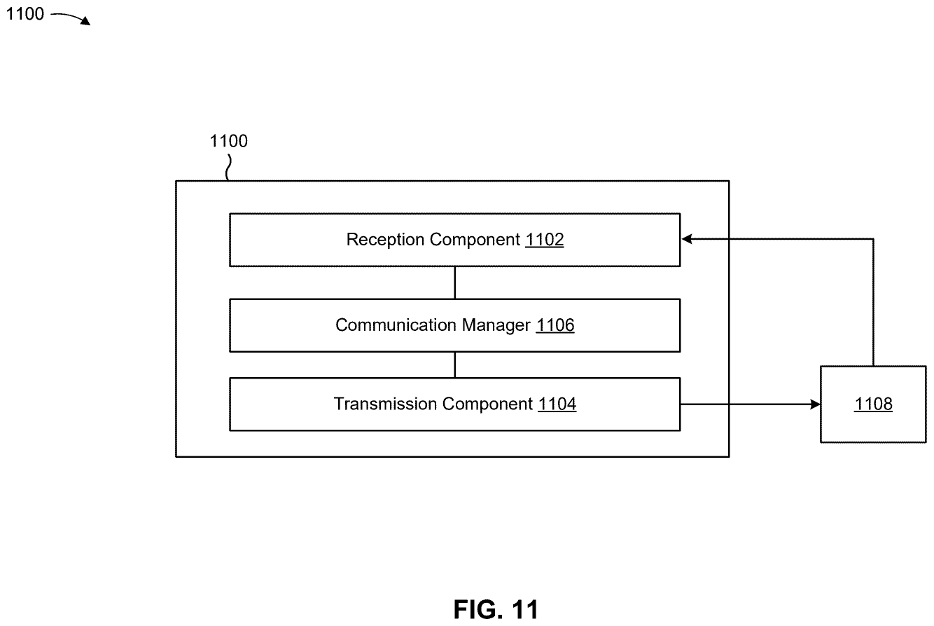

In some aspects, the network node 110 includes means for receiving a UE capability indication associated with multiplexing; means for transmitting an OCC configuration that indicates an OCC-multiplexing factor; or means for receiving or refrain from receiving a PTRS in accordance with a PTRS rule associated with the OCC configuration. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

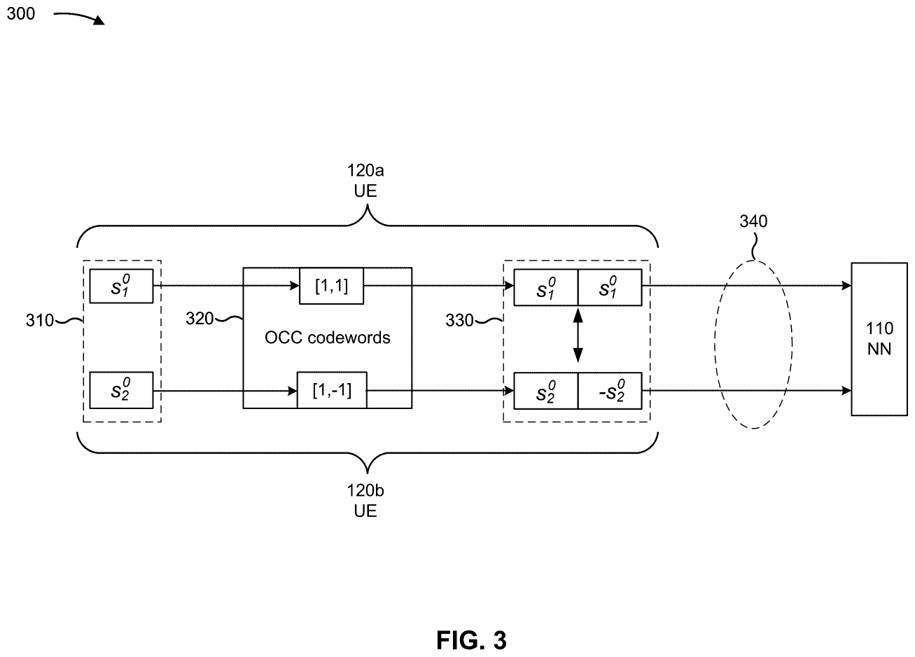

FIG. 3 is a diagram illustrating an example 300 of OCC for two UEs 120a and 120b.

An OCC procedure may involve an OCC multiplexing factor M, which denotes a quantity of UEs multiplexed by the OCC procedure. In example 300, M=2, corresponding to UEs 120a and 120b. As shown by reference number 310, the UE 120a may generate a first signal s₁⁰, and the UE 120b may generate a second signal s₂⁰, where a signal sᵢ^{j} is associated with a resource element (RE) j by UE i. In some examples, a signal sᵢ^{j} may be associated with a time resource (for example, a symbol or a slot, among other examples) referred to as an “original entity.”

As shown by reference number 320, the UE 120a may apply a first OCC codeword of [1, 1] to the first signal

$${s}_{1}^{0} ,$$

and the UE 120b may apply a second OCC codeword of [1, −1] to the second symbol

$${s}_{2}^{0} .$$

The OCC codewords may have a quantity of elements equal to the OCC multiplexing factor M (here, 2).

As shown by reference number 330, responsive to the application of the OCC codewords, the first signal

$${s}_{1}^{0}$$

may be converted to multiple first signals

$${s}_{1}^{0} and {s}_{1}^{0} ,$$

and the second signal

$${s}_{2}^{0}$$

may converted to multiple second signals

$${s}_{2}^{0} and {- s}_{2}^{0} .$$

As a result, an original entity may be converted (or “spread”) into multiple spread entities, where a quantity of the multiple spread entities is equal to the OCC multiplexing factor M (here, 2). The multiple first signals

$${s}_{1}^{0} and {s}_{1}^{0}$$

may be orthogonal to the multiple second signals

$${s}_{2}^{0} and {- s}_{2}^{0} .$$

As shown by reference number 340, the UEs 120a and 120b may transmit, and the network node 110 may receive, the multiple first signals

$${s}_{1}^{0} and {s}_{1}^{0}$$

and the multiple second signals

$${s}_{2}^{0} and {- s}_{2}^{0} .$$

Being orthogonal to each other, these signals may share the same REs. Thus, OCC may multiplex the UEs 120a and 120b while mitigating interference at the network node 110.

In some examples, OCC may be used to enhance PUSCH capacity for NTNs. For example, OCC applied to PUSCH transmission with repetition may, due to the repetitive nature of the PUSCH transmission, enable the PUSCH transmission without sacrificing resource efficiency. For example, multiple UEs 120 may transmit PUSCH communications with OCC on a time-frequency resource with minimal performance degradation, and each UE 120 may achieve capacity enhancement from repetition of the PUSCH communications.

The grid structure of OFDM, which can have different types of resource allocations and TB over multiple slots (TBoMS), may enable OCC across symbols, slots, or frequencies. In some examples, OCC for PUSCH in NTNs may be slot-level. For example, an OCC procedure may spread one slot into M slots.

As indicated above, FIG. 3 is provided as an example. Other examples may differ from what is described with respect to FIG. 3.

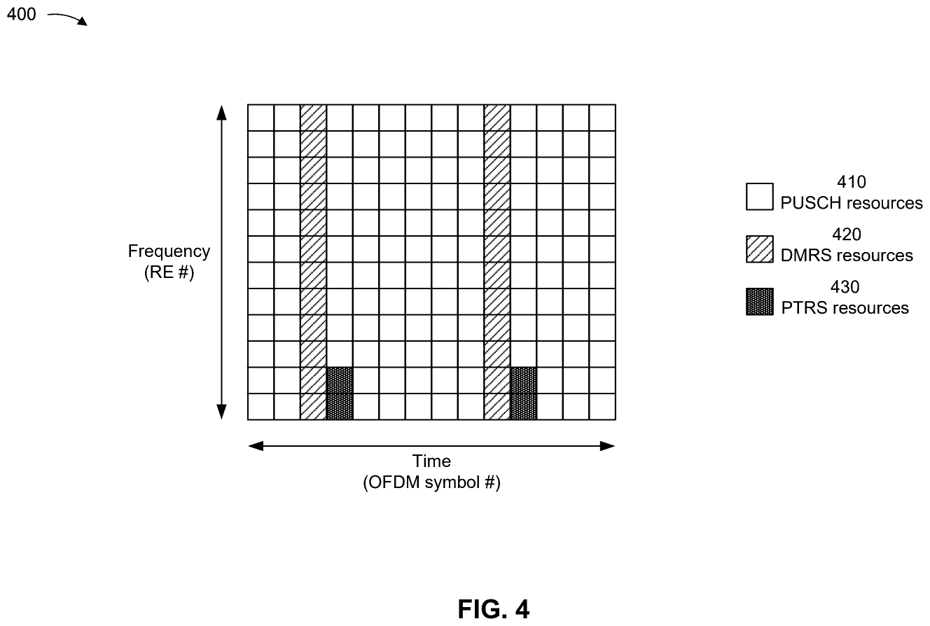

FIG. 4 is a diagram illustrating an example 400 of a PUSCH allocation for one OFDM slot and one RB.

Example 400 shows a PUSCH allocation configured with PUSCH resources 410, DMRS resources 420, and PTRS resources 430. The DMRS resources 420 are configured in all REs of the third and tenth OFDM symbols of the OFDM slot. The PTRS resources 430 are configured in the first and second REs of the fourth and eleventh OFDM symbols of the OFDM slot. In some examples, when PTRS presence is configured, one PTRS port may be present in every OFDM symbol and at least every second RB (unless downlink or uplink density tables are configured otherwise via RRC). For example, PTRS presence may be configured by enabling a DL-PTRS-present parameter or an UL-PTRS-present parameter.

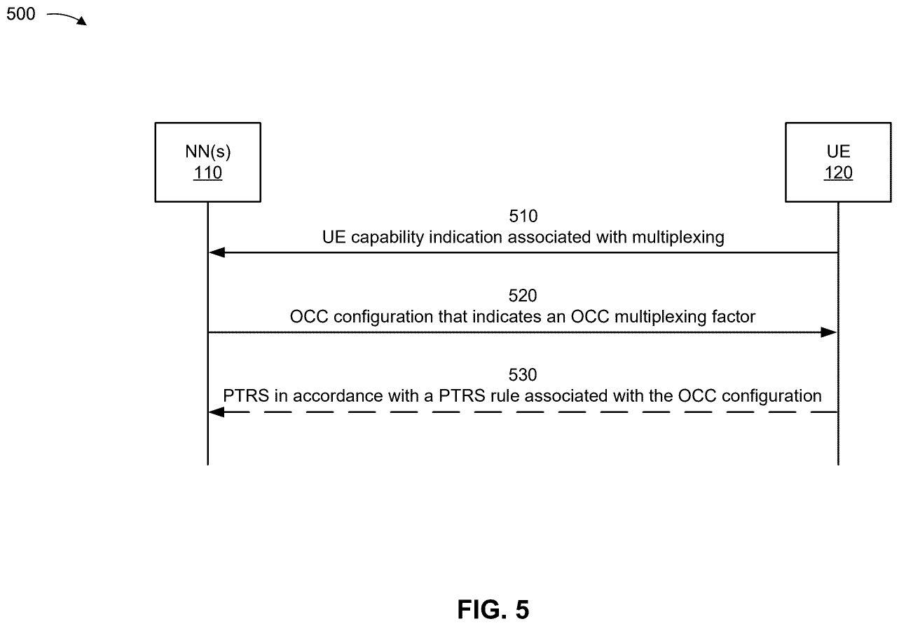

Example 400 shows a PUSCH allocation for PTRS (e.g., uplink PTRS) without OCC. Whether or how a PUSCH using OCC (e.g., for NTN) allows for PTRS transmission can impact one or more of CFO estimation, capacity, overhead, performance, or the like. For example, if a system that is using OCC and sensitive to CFO cannot use uplink PTRS, then the network (e.g., a minimum mean squared error (MMSE) network receiver responsible for performing de-OCC using CFO information) may be unable to accurately estimate CFO and, thus, may be unable to accurately decode the PUSCH. As a result, the performance of the system may suffer, which may lead to decreased uplink capacity. Additionally, or alternatively, if a system (e.g., an NTN system) that is using OCC and has limited bandwidth (e.g., low RB allocation) uses uplink PTRS, then the PTRS may increase overhead and use resources that could otherwise be used for data. Such systems may sufficiently estimate CFO using DMRSs. Additionally, or alternatively, if a system that is using OCC has a low link budget (e.g., low operating signal-to-noise ratio (SNR)), then the PTRS may offer little or no help in estimating impairments accurately and contribute to additional overhead, which may decrease uplink capacity. Thus, on balance, uplink PTRS may or may not be useful for systems that use OCC. Accordingly, as discussed in greater detail below in connection with FIGS. 5-7, aspects provided herein relate to rules for configuration of uplink PTRS with OCC.

As indicated above, FIG. 4 is provided as an example. Other examples may differ from what is described with respect to FIG. 4.

FIG. 5 is a diagram illustrating an example 500 of signaling associated with rules for configuration of uplink PTRS with OCC.

As shown by reference number 510, the UE 120 may transmit, and the network node 110 may receive, a UE capability indication associated with multiplexing. The UE capability indication may be associated with multiplexing in that the UE capability indication may indicate that the UE 120 can support multiplexing. In some examples, a capability of the UE 120 to support multiplexing may depend on one or more phase coherence capabilities of the UE 120.

As shown by reference number 520, the network node 110 may transmit, and the UE 120 may receive, an OCC configuration that indicates an OCC multiplexing factor. The OCC multiplexing factor may be the OCC multiplexing factor M as discussed above in connection with FIG. 3. Additionally, or alternatively, the OCC configuration may indicate an OCC codeword as discussed above in connection with FIG. 3. The network node 110 may transmit the OCC configuration via RRC, MAC-CE, DCI, or the like.

As shown by reference number 530, the UE 120 may transmit or refrain from transmitting (e.g., selectively transmit), and the network node 110 may receive or refrain from receiving (e.g., selectively receive), a PTRS in accordance with a PTRS rule associated with the OCC configuration. The PTRS rule may indicate whether or how the UE 120 can transmit the PTRS. The PTRS rule may be associated with the OCC configuration in that the PTRS rule may indicate whether or how the UE 120 can transmit the PTRS based at least in part on the OCC configuration (e.g., a presence of the OCC configuration or one or more parameters of the OCC configuration, such as the OCC multiplexing factor M or the OCC codeword).

In some aspects, selectively transmitting the PTRS may include refraining from transmitting the PTRS, and selectively receiving the PTRS may include refraining from receiving the PTRS. As used herein, “selectively” performing an operation means to either perform the operation or refrain from performing the operation. For example, selectively transmitting or receiving the PTRS in accordance with the PTRS rule may mean refraining from transmitting or receiving the PTRS based at least in part on the PTRS rule indicating that the UE 120 is not to transmit, and the network node 110 is not to receive, the PTRS. Thus, selectively transmitting or receiving the PTRS may include identifying whether or not to transmit or receive the PTRS and then refraining from transmitting or receiving the PTRS.

In some aspects (e.g., where selectively transmitting the PTRS includes refraining from transmitting the PTRS, and selectively receiving the PTRS includes refraining from receiving the PTRS), the PTRS rule may indicate that the OCC configuration precludes PTRS configuration. For example, the PTRS rule may indicate that OCC and PTRS cannot be configured simultaneously. For example, the PTRS rule may indicate that, if OCC is configured, then PTRS cannot be used. As a result, the UE 120 (which received the OCC configuration as discussed above in connection with reference number 520 and is thus configured to perform OCC) may not expect to be configured with PTRS.

In some aspects (e.g., where selectively transmitting the PTRS includes refraining from transmitting the PTRS, and selectively receiving the PTRS includes refraining from receiving the PTRS), the PTRS rule may indicate that the OCC configuration precludes PTRS transmission. For example, the PTRS rule may indicate that, if OCC and PTRS are configured simultaneously, then the UE 120 cannot use PTRS in uplink transmissions. As a result, if the network node 110 configures OCC transmission (e.g., via the OCC configuration as discussed above in connection with reference number 520) and configures PTRS for OCC transmissions, then the UE 120 may ignore the PTRS configuration and use OCC for uplink transmissions without PTRS.

In some aspects, selectively transmitting the PTRS may include transmitting the PTRS, and selectively receiving the PTRS may include receiving the PTRS. For example, selectively transmitting or receiving the PTRS in accordance with the PTRS rule may mean refraining from transmitting or receiving the PTRS based at least in part on the PTRS rule indicating that the UE 120 is not to transmit, and the network node 110 is not to receive, the PTRS. Thus, selectively transmitting or receiving the PTRS may include identifying whether or not to transmit or receive the PTRS and then refraining from transmitting or receiving the PTRS.

In some aspects (e.g., where selectively transmitting the PTRS includes transmitting the PTRS, and selectively receiving the PTRS includes receiving the PTRS), the PTRS rule may indicate that PTRS transmission is performed using an OCC codeword. For example, the PTRS rule may indicate that, if OCC and PTRS are configured simultaneously, then the UE 120 can use OCC for PTRS transmissions. For example, if the network node 110 configures OCC transmission (e.g., via the OCC configuration as discussed above in connection with reference number 520) and configures PTRS for OCC transmissions, then the UE 120 may use OCC for PTRS transmissions. In some examples, the UE 120 may use the same OCC codewords for PUSCH (e.g., data) transmission and PTRS transmission. For example, the OCC codewords may be configured via the OCC configuration as discussed above in connection with reference number 520. In some examples, the UE 120 may use different OCC codewords for PUSCH (e.g., data) transmission and PTRS transmission. For example, the OCC codewords for PUSCH (e.g., data) transmission may be configured via the OCC configuration as discussed above in connection with reference number 520, and separate OCC codewords for PTRS transmission may be configured. For example, the network node 110 may transmit, and the UE 120 may receive, an indication of the OCC codewords to use for PTRS transmission. The indication may be carried via RRC, MAC-CE, DCI, or the like.

In some aspects (e.g., where selectively transmitting the PTRS includes transmitting the PTRS, and selectively receiving the PTRS includes receiving the PTRS), the PTRS rule may indicate that PTRS transmission is not performed using an OCC codeword. For example, the PTRS rule may indicate that, if OCC and PTRS are configured simultaneously, then the UE 120 can transmit PTRSs without OCC. For example, if the network node 110 configures OCC transmission (e.g., via the OCC configuration as discussed above in connection with reference number 520) and configures PTRS for OCC transmissions, then the UE 120 may not use OCC for PTRS transmissions. For example, the UE 120 may use a configured resource assigned to transmit the PTRS without OCC.

In some aspects, the network node 110 may transmit, and the UE 120 may receive, an indication of the PTRS rule. For example, if multiple PTRS rules can be configured, then the network node 110 may indicate to the UE 120 which PTRS rule to use. Additionally, or alternatively, the network node 110 may configure the UE 120 with UE-specific details regarding PTRS configuration with OCC. The network node 110 may configure the UE 120 via RRC, MAC-CE, DCI, or the like.

As indicated above, FIG. 5 is provided as an example. Other examples may differ from what is described with respect to FIG. 5.

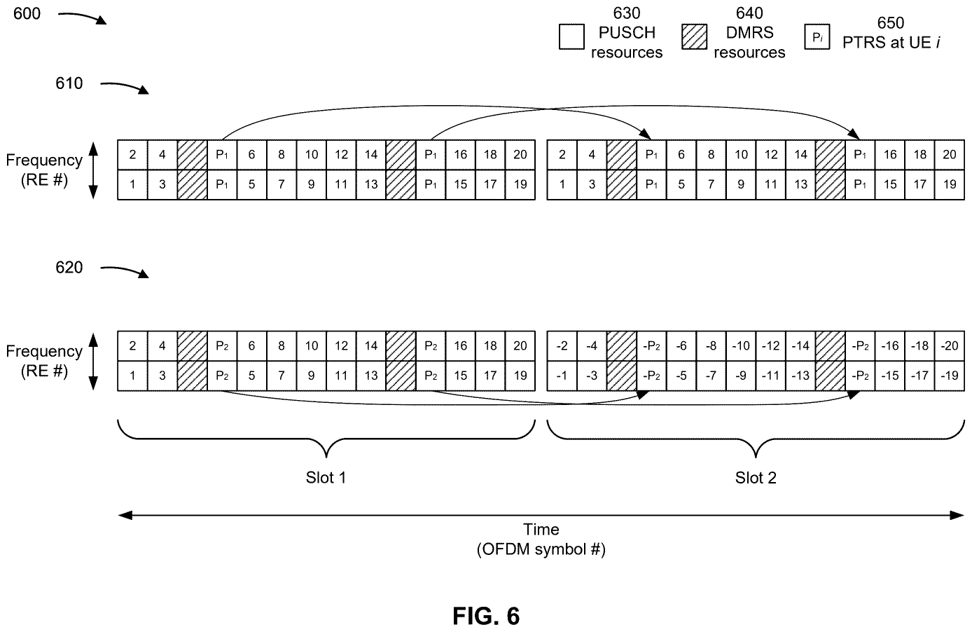

FIG. 6 is a diagram illustrating an example 600 where the PTRS rule indicates that PTRS transmission is performed using an OCC codeword.

As shown by reference number 610, the UE 120a may transmit uplink communications in slot 1 and slot 2 using an OCC codeword [1,1]. As shown by reference number 620, the UE 120b may transmit uplink communications in slot 1 and slot 2 using an OCC codeword [1,−1]. The UEs 120a and 120b may transmit the uplink communications in PUSCH resources 630, DMRS resources 640, and PTRS resources. For example, the UE 120a may transmit a PTRS 650 using an OCC codeword [1,1], and the UE 120b may transmit a PTRS 650 using an OCC codeword [1,−1]. In example 600, only the REs that include the PTRSs 650 are shown.

As indicated above, FIG. 6 is provided as an example. Other examples may differ from what is described with respect to FIG. 6.

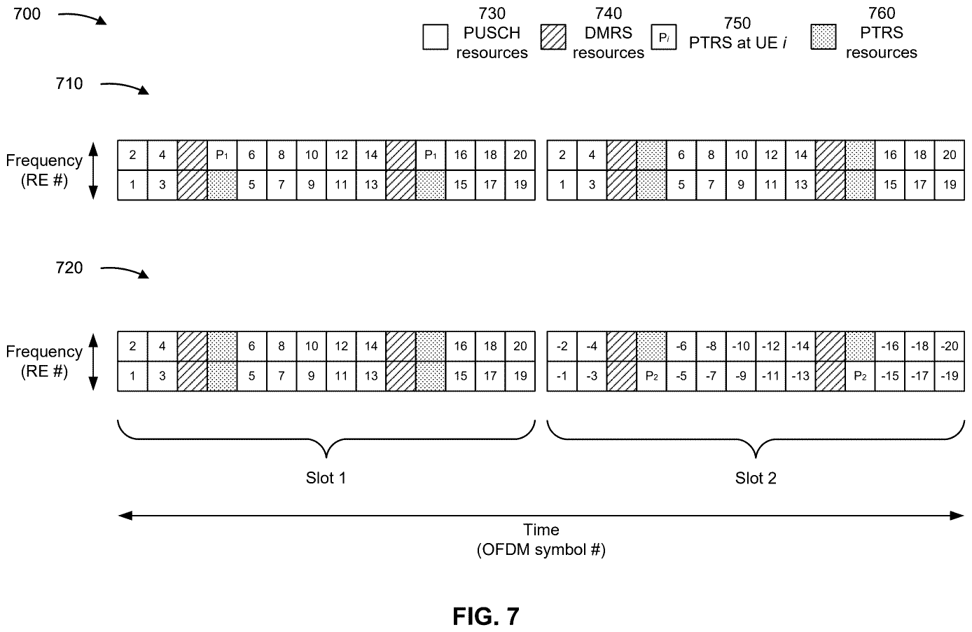

FIG. 7 is a diagram illustrating an example 700 where the PTRS rule indicates that PTRS transmission is not performed using an OCC codeword.

As shown by reference number 710, the UE 120a may transmit uplink communications in slot 1 and slot 2 using an OCC codeword [1,1]. As shown by reference number 720, the UE 120b may transmit uplink communications in slot 1 and slot 2 using an OCC codeword [1,−1]. The UEs 120a and 120b may transmit the uplink communications in PUSCH resources 730, DMRS resources 740, and PTRS resources.

For example, the UE 120a may transmit a PTRS 750 without using an OCC codeword [1,1], and the UE 120b may transmit a PTRS 750 without using an OCC codeword [1,−1]. Thus, the UE 120a and the UE 120b may transmit PTRSs 750 in alternating slots (e.g., the UE 120a may transmit PTRSs in slot 1, and the UE 120b may transmit PTRSs in slot 2). PTRS resources 760 may not carry PTRSs. In example 700, only the REs that include the PTRSs 750 are shown.

As indicated above, FIG. 7 is provided as an example. Other examples may differ from what is described with respect to FIG. 7.

Transmitting or refraining from transmitting, or receiving or refraining from receiving, a PTRS in accordance with a PTRS rule may help to improve a CFO estimation, capacity, overhead, performance, or the like. For example, if the UE 120 is using OCC and uplink communications are sensitive to CFO, then the PTRS rule may allow the UE 120 to use uplink PTRS, which may enable the network node 110 to accurately estimate CFO and, thus, accurately decode the PUSCH. As a result, performance may improve, which may lead to increased uplink capacity. Additionally, or alternatively, if the UE 120 is using OCC and the uplink communications have limited bandwidth, then the PTRS rule may cause the UE 120 to skip uplink PTRS, which may help to decrease overhead and provide additional resources that can be used for data (in this case, the network node 110 may estimate CFO sufficiently using DMRSs). Additionally, or alternatively, if the UE 120 is using OCC and has a low link budget, then the PTRS rule may cause the UE 120 to skip uplink PTRS, which may help to decrease overhead and, thus, increase uplink capacity.

The PTRS rule indicating that the OCC configuration precludes PTRS configuration may help to reduce overhead by skipping PTRS configuration. Additionally, or alternatively, processing or memory resource utilization at the UE 120 may be reduced because the UE 120 may avoid identifying whether the UE 120 can transmit a PTRS.

The PTRS rule indicating that the OCC configuration precludes PTRS transmission may help to reduce processing or memory resource utilization at the network node 110 by enabling the network node 110 to avoid identifying whether the UE 120 can receive a PTRS configuration.

The PTRS rule indicating that PTRS transmission is performed using an OCC codeword may help to improve uplink capacity (e.g., resource utilization efficiency) by enabling multiplexing of PTRS using OCC. For example, multiplexing PTRSs using OCC may provide a processing gain that helps to improve PTRS demodulation, which may in turn improve CFO estimation. Additionally, or alternatively, processing or memory resource utilization at the network node 110 may be reduced because the network node 110 may avoid precise scheduling of PTRSs whereby all PTRS resources are used by the UEs 120a and 120b without allowing the PTRSs to overlap, which would create interference and render the PTRSs undecodable.

The PTRS rule indicating that PTRS transmission is not performed using an OCC codeword may help to reduce processing or memory resource utilization at the UE 120 by allowing the UE 120 to avoid applying OCC codewords to PTRSs.

FIG. 8 is a diagram illustrating an example process 800 performed, for example, at a UE or an apparatus of a UE. Example process 800 is an example where the apparatus or the UE (e.g., UE 120) performs operations associated with PTRS with OCC.

As shown in FIG. 8, in some aspects, process 800 may include transmitting a UE capability indication associated with multiplexing (block 810). For example, the UE (e.g., using transmission component 1004 or communication manager 1006, depicted in FIG. 10) may transmit a UE capability indication associated with multiplexing, as described above.

As further shown in FIG. 8, in some aspects, process 800 may include receiving an OCC configuration that indicates an OCC-multiplexing factor (block 820). For example, the UE (e.g., using reception component 1002 or communication manager 1006, depicted in FIG. 10) may receive an OCC configuration that indicates an OCC-multiplexing factor, as described above.

As further shown in FIG. 8, in some aspects, process 800 may include transmitting or refraining from transmitting a PTRS in accordance with a PTRS rule associated with the OCC configuration (block 830). For example, the UE (e.g., using transmission component 1004 or communication manager 1006, depicted in FIG. 10) may transmit or refrain from transmitting a PTRS in accordance with a PTRS rule associated with the OCC configuration, as described above.

Process 800 may include additional aspects, such as any single aspect or any combination of aspects described below or in connection with one or more other processes described elsewhere herein.

In a first aspect, transmitting or refraining from transmitting the PTRS includes refraining from transmitting the PTRS.

In a second aspect, alone or in combination with the first aspect, the PTRS rule indicates that the OCC configuration precludes PTRS configuration.

In a third aspect, alone or in combination with one or more of the first and second aspects, the PTRS rule indicates that the OCC configuration precludes PTRS transmission.

In a fourth aspect, alone or in combination with one or more of the first through third aspects, transmitting or refraining from transmitting the PTRS includes transmitting the PTRS.

In a fifth aspect, alone or in combination with one or more of the first through fourth aspects, the PTRS rule indicates that PTRS transmission is performed using an OCC codeword.

In a sixth aspect, alone or in combination with one or more of the first through fifth aspects, the PTRS rule indicates that PTRS transmission is not performed using an OCC codeword.

In a seventh aspect, alone or in combination with one or more of the first through sixth aspects, process 800 includes receiving an indication of the PTRS rule.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with PTRS with OCC.

As shown in FIG. 9, in some aspects, process 900 may include receiving a UE capability indication associated with multiplexing (block 910). For example, the network node (e.g., using reception component 1102 or communication manager 1106, depicted in FIG. 11) may receive a UE capability indication associated with multiplexing, as described above.

As further shown in FIG. 9, in some aspects, process 900 may include transmitting an OCC configuration that indicates an OCC-multiplexing factor (block 920). For example, the network node (e.g., using transmission component 1104 or communication manager 1106, depicted in FIG. 11) may transmit an OCC configuration that indicates an OCC-multiplexing factor, as described above.

As further shown in FIG. 9, in some aspects, process 900 may include receiving or refraining from receiving a PTRS in accordance with a PTRS rule associated with the OCC configuration (block 930). For example, the network node (e.g., using reception component 1102 or communication manager 1106, depicted in FIG. 11) may receive or refrain from receiving a PTRS in accordance with a PTRS rule associated with the OCC configuration, as described above.

Process 900 may include additional aspects, such as any single aspect or any combination of aspects described below or in connection with one or more other processes described elsewhere herein.

In a first aspect, receiving or refraining from receiving the PTRS includes refraining from receiving the PTRS.

In a second aspect, alone or in combination with the first aspect, the PTRS rule indicates that the OCC configuration precludes PTRS configuration.

In a third aspect, alone or in combination with one or more of the first and second aspects, the PTRS rule indicates that the OCC configuration precludes PTRS transmission.

In a fourth aspect, alone or in combination with one or more of the first through third aspects, receiving or refraining from receiving the PTRS includes receiving the PTRS.

In a fifth aspect, alone or in combination with one or more of the first through fourth aspects, the PTRS rule indicates that PTRS transmission is performed using an OCC codeword.

In a sixth aspect, alone or in combination with one or more of the first through fifth aspects, the PTRS rule indicates that PTRS transmission is not performed using an OCC codeword.

In a seventh aspect, alone or in combination with one or more of the first through sixth aspects, process 900 includes transmitting an indication of the PTRS rule.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit a UE capability indication associated with multiplexing. The reception component 1002 may receive an OCC configuration that indicates an OCC-multiplexing factor. The transmission component 1004 may transmit or refrain from transmitting a PTRS in accordance with a PTRS rule associated with the OCC configuration. In some aspects, the reception component 1002 may receive an indication of the PTRS rule.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The reception component 1102 may receive a UE capability indication associated with multiplexing. The transmission component 1104 may transmit an OCC configuration that indicates an OCC-multiplexing factor. The reception component 1102 may receive or refrain from receiving a PTRS in accordance with a PTRS rule associated with the OCC configuration. In some aspects, the transmission component 1104 may transmit an indication of the PTRS rule.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: transmitting a UE capability indication associated with multiplexing; receiving an orthogonal cover code (OCC) configuration that indicates an OCC-multiplexing factor; and transmitting or refraining from transmitting a phase tracking reference signal (PTRS) in accordance with a PTRS rule associated with the OCC configuration.
Aspect 2: The method of Aspect 1, wherein transmitting or refraining from transmitting the PTRS includes refraining from transmitting the PTRS.
Aspect 3: The method of Aspect 2, wherein the PTRS rule indicates that the OCC configuration precludes PTRS configuration.
Aspect 4: The method of Aspect 2, wherein the PTRS rule indicates that the OCC configuration precludes PTRS transmission.
Aspect 5: The method of any of Aspects 1-4, wherein transmitting refraining from transmitting the PTRS includes transmitting the PTRS.
Aspect 6: The method of Aspect 5, wherein the PTRS rule indicates that PTRS transmission is performed using an OCC codeword.
Aspect 7: The method of Aspect 5, wherein the PTRS rule indicates that PTRS transmission is not performed using an OCC codeword.
Aspect 8: The method of any of Aspects 1-7, further comprising: receiving an indication of the PTRS rule.
Aspect 9: A method of wireless communication performed by a network node, comprising: receiving a user equipment (UE) capability indication associated with multiplexing; transmitting an orthogonal cover code (OCC) configuration that indicates an OCC-multiplexing factor; and receiving or refraining from receiving a phase tracking reference signal (PTRS) in accordance with a PTRS rule associated with the OCC configuration.
Aspect 10: The method of Aspect 9, wherein receiving or refraining from receiving the PTRS includes refraining from receiving the PTRS.
Aspect 11: The method of Aspect 10, wherein the PTRS rule indicates that the OCC configuration precludes PTRS configuration.
Aspect 12: The method of Aspect 10, wherein the PTRS rule indicates that the OCC configuration precludes PTRS transmission.
Aspect 13: The method of any of Aspects 9-12, wherein receiving or refraining from receiving the PTRS includes receiving the PTRS.
Aspect 14: The method of Aspect 13, wherein the PTRS rule indicates that PTRS transmission is performed using an OCC codeword.
Aspect 15: The method of Aspect 13, wherein the PTRS rule indicates that PTRS transmission is not performed using an OCC codeword.
Aspect 16: The method of any of Aspects 9-15, further comprising: transmitting an indication of the PTRS rule.
Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.
Aspect 18: An apparatus for wireless communication at a device, the apparatus comprising one or more memories and one or more processors coupled to the one or more memories, the one or more processors configured to cause the device to perform the method of one or more of Aspects 1-16.
Aspect 19: An apparatus for wireless communication, the apparatus comprising at least one means for performing the method of one or more of Aspects 1-16.
Aspect 20: A non-transitory computer-readable medium storing code for wireless communication, the code comprising instructions executable by one or more processors to perform the method of one or more of Aspects 1-16.
Aspect 21: A non-transitory computer-readable medium storing a set of instructions for wireless communication, the set of instructions comprising one or more instructions that, when executed by one or more processors of a device, cause the device to perform the method of one or more of Aspects 1-16.
Aspect 22: A device for wireless communication, the device comprising a processing system that includes one or more processors and one or more memories coupled with the one or more processors, the processing system configured to cause the device to perform the method of one or more of Aspects 1-16.
Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.
Aspect 24: A device comprising a processing system that includes one or more processors and one or more code-storing memories coupled with the one or more processors, the processing system configured to cause the device to perform the method of one or more of Aspects 1-16.
Aspect 25: A device comprising a processing system that includes processor circuitry and code-storing memory circuitry, the processing system configured to cause the device to perform the method of one or more of Aspects 1-16.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
transmit a UE capability indication associated with multiplexing;
receive an orthogonal cover code (OCC) configuration that indicates an OCC-multiplexing factor; and
transmit or refrain from transmitting a phase tracking reference signal (PTRS) in accordance with a PTRS rule associated with the OCC configuration.

2. The UE of claim 1, wherein the processing system, to cause the UE to transmit or refrain from transmitting the PTRS, is configured to cause the UE to refrain from transmitting the PTRS.

3. The UE of claim 2, wherein the PTRS rule indicates that the OCC configuration precludes PTRS configuration.

4. The UE of claim 2, wherein the PTRS rule indicates that the OCC configuration precludes PTRS transmission.

5. The UE of claim 1, wherein the processing system, to cause the UE to transmit or refrain from transmitting the PTRS, is configured to cause the UE to transmit the PTRS.

6. The UE of claim 5, wherein the PTRS rule indicates that PTRS transmission is performed using an OCC codeword.

7. The UE of claim 5, wherein the PTRS rule indicates that PTRS transmission is not performed using an OCC codeword.

8. The UE of claim 1, wherein the processing system is configured to cause the UE to:
receive an indication of the PTRS rule.

9. A network node, comprising:
a processing system that includes processor circuitry and code-storing memory circuitry, the processing system configured to cause the network node to:
receive a user equipment (UE) capability indication associated with multiplexing;
transmit an orthogonal cover code (OCC) configuration that indicates an OCC-multiplexing factor; and
receive or refrain from receiving a phase tracking reference signal (PTRS) in accordance with a PTRS rule associated with the OCC configuration.

10. The network node of claim 9, wherein the processing system, to cause the network node to receive or refrain from receiving the PTRS, is configured to cause the network node to refrain from receiving the PTRS.

11. The network node of claim 10, wherein the PTRS rule indicates that the OCC configuration precludes PTRS configuration.

12. The network node of claim 10, wherein the PTRS rule indicates that the OCC configuration precludes PTRS transmission.

13. The network node of claim 9, wherein the processing system, to cause the network node to receive or refrain from receiving the PTRS, is configured to cause the network node to receive the PTRS.

14. The network node of claim 13, wherein the PTRS rule indicates that PTRS transmission is performed using an OCC codeword.

15. The network node of claim 13, wherein the PTRS rule indicates that PTRS transmission is not performed using an OCC codeword.

16. The network node of claim 9, wherein the processing system is configured to cause the network node to:
transmit an indication of the PTRS rule.

17. A method of wireless communication performed by a user equipment (UE), comprising:
transmitting a UE capability indication associated with multiplexing;
receiving an orthogonal cover code (OCC) configuration that indicates an OCC-multiplexing factor; and
transmitting or refraining from transmitting a phase tracking reference signal (PTRS) in accordance with a PTRS rule associated with the OCC configuration.

18. The method of claim 17, wherein transmitting or refraining from transmitting the PTRS includes refraining from transmitting the PTRS.

19. The method of claim 18, wherein the PTRS rule indicates that the OCC configuration precludes PTRS configuration.

20. The method of claim 18, wherein the PTRS rule indicates that the OCC configuration precludes PTRS transmission.
